(19) United States
(12) Patent Application Publication
(10) Pub. No.: US 2022/0414625 A1
(43) Pub. Date: Dec. 29, 2022

(54) SECURE PAYMENT SYSTEMS AND METHODS

(71) Applicant: Closinglock, LLC, Austin, TX (US)

(72) Inventor: Andrew J. White, Austin, TX (US)

(73) Assignee: Closinglock, LLC, Austin, TX (US)

(21) Appl. No.: 17/362,698

(22) Filed: Jun. 29, 2021

(51) Int. Cl. G06Q 20/10; G06Q 20/38; G06Q 50/16

(52) U.S. Cl. CPC G06Q 20/102; G06Q 20/382; G06Q 50/16

(57) ABSTRACT

A method may comprise: receiving, via a secure payment system, transaction information associated with a real estate transaction, the transaction information including an escrow account, a buyer name, and a buyer contact, the escrow account configured to receive a good funds payment for an earnest money deposit or a closing payment; receiving, via the secure payment system, a first request to transfer the good funds payment from a user account of a user to the escrow account; querying, via the secure payment system, information associated with the user account; generating, via the secure payment system, a second request for payment to a financial institution of the user account; receiving, via the secure payment system, a notification that the second request for payment was approved by the user; and in response to receiving the notification, transferring the good funds payment from the user account of the user to a secure payment account of the secure payment system.

### FIELD

The present disclosure relates generally to secure payment systems and methods for transferring good funds from an individual to an escrow or title company, in particular secure payment systems and methods for transferring large sums of good funds for real estate transactions (e.g., refinance, all cash, mortgage purchase, etc.).

### BACKGROUND

Closing on a home involves several significant events, such as transferring a home title from a seller to a buyer, proceeds of the sale being distributed to the seller and/or signing a buyer's note. Due to the large amount of money being transferred between individuals, and legal requirements of “good funds”, the process has remained relatively manual despite mass improvements in technology. In particular, options for paying a final balance due at closing in typical systems are certified or cashier's checks, which have to be retrieved manually from a local bank, or a wire transfer, which often requires in person verification.

Wire transfers are typically allowed for home closing due to being considered relatively safe and they facilitate good funds transfers. Wire transfers are not initiated immediately and may take multiple days to complete. The lack of anonymity when banking in the U.S. limits thieves' ability to pull off a scam with a bank wire transfer to a degree. However, lately, wiring scams have been targeting, and succeeding with respect to final closing payments. In particular, scammers are increasingly targeting real estate professionals, seeking to compromise their email in order to monitor email correspondence with clients and identify upcoming real estate transactions. During the closing process, scammers send spoofed emails to the home buyer—posing as the real estate agent, settlement agent, legal representative or another trusted individual—with false instructions for wiring closing funds. In this regard, in response to a buyer following the false instructions, the buyer may wire a large sum of money meant for closing to the scammer.

The reason that only wire transfers, certified checks, and cashiers' checks are used in typical home closing systems and processes—is the requirement for good funds at closing and may be required for earnest money deposits. “Good funds” as disclosed herein refers to “immediately available and irrevocable funds.” A wire is considered good funds because the funds are wired from a first user's bank directly to a title companies' bank via the Federal Reserve and are immediately available and irrevocable. A cashier's check is also immediately available and irrevocable as it is withdrawn from the bank account upon receiving the cashier's check. Although cashier's checks and wire transfers are immediately available, they are not immediately settled. A certified check may be considered good funds because the certified check is stamped and certified by a bank official that the funds are available in the account.

### SUMMARY

A method of transferring good funds is disclosed herein. The method may comprise: receiving, via a secure payment system, transaction information associated with a real estate transaction, the transaction information including an escrow account, a user's name, and a user's contact, the escrow account configured to receive a good funds payment; receiving, via the secure payment system, a first request to transfer the good funds payment from a user account of a user to the escrow account; querying, via the secure payment system, information associated with the user account; generating, via the secure payment system, a second request for payment to a financial institution associated with the user account; receiving, via the secure payment system, a notification that the second request for payment was approved by the user; and in response the second request for payment being approved by the user, immediately and irrevocably transferring the good funds payment from the user account of the user to a secure payment account of the secure payment system.

In various embodiments, the first request to transfer the good funds payment is initiated by the user. The transferring the good funds payment may be initiated in response to the user approving the second request for payment through the financial institution. The good funds payment may be settled within the secure payment account within three minutes of the transferring the good funds payment being initiated by the user. The first request to transfer the good funds payment and approval of the second request for payment may both performed by the user. Receiving the first request to transfer the good funds payment may be received through a secure payment user interface (UI). Querying the information associated with the user account may be performed through the secure payment UI.

A system for transferring good funds is disclosed herein. The system may comprise: a network of first financial institutions, each financial institution in the network of first financial institutions including a plurality of individual accounts; a network of second financial institutions, each second financial institution in the network of second financial institutions including a plurality of escrow accounts, each escrow account in the plurality of escrow accounts being opened to facilitate a home buying process; a secure payment system comprising a processor, a secure payment account, and a tangible, non-transitory memory configured to communicate with the processor, the tangible, non-transitory memory having instructions stored thereon that, in response to execution by the processor, cause the processor to perform operations comprising: receiving, via the processor, a first request to transfer a good funds payment from a user account in the plurality of individual accounts to a user associated escrow account in the plurality of escrow accounts; querying, via the processor, information associated with the user account; determining, via the processor, a user financial institution in the network of first financial institutions associated with the user account of a user in response to querying the information associated with the user account; generating, via the processor, a second request for payment to the user financial institution; and receiving, via the processor, a notification that the user approved the second request for payment, wherein in response to the second request for payment being approved, the good funds payment is automatically transferred from the user account to the secure payment account.

In various embodiments, in response to receiving the good funds payment in the secure payment account, the good funds payment is automatically transferred to the user associated escrow account. The user financial institution may comprise a financial system including a graphical user interface (GUI), and approval of the second request for payment is received from the user through the GUI of the financial system of the user financial institution. In various embodiments, the transferring the good funds payment is initiated in response to the user approving the second request for payment through the user financial institution. The good funds payment may be settled within the secure payment account within three minutes of the transferring the good funds payment being initiated by the user. The secure payment system may further comprise a secure payment user interface (UI), and the processor may be configured to generate a portal for the user in response to a user name and a user contact being provided for a respective transaction. The secure payment UI may configured to allow the user to access the portal.

An article of manufacture is disclosed herein. The article of manufacture may include a tangible, non-transitory computer-readable storage medium having instructions stored thereon that, in response to execution by a processor, cause the processor to perform operations comprising: receiving, via the processor, a first request to transfer a good funds payment from a user account into an escrow account, the escrow account configured to receive one of an earnest money deposit and a final closing payment; querying, via the processor, information associated with the user account; determining, via the processor and in response to the querying, a financial institution associated with the user account and an amount for the good funds payment; generating, via the processor, a second request for payment to the financial institution; receiving, via the processor, a notification of approval for the second request for payment; and in response to an approval by a user of the second request for payment, the amount for the good funds payment is immediately and irrevocably transferred from the user account to a secure payment account associated with the escrow account.

In various embodiments, the transferring the good funds payment is initiated in response to the user approving the second request for payment through the financial institution. The operations may further comprise generating, via the processor, a notification to the user that the good funds payment is due, the notification including one of an email and a text message, the notification comprising a link. In response to receiving the good funds payment in the secure payment account, the good funds payment may be transferred to a user associated escrow account. The operations may further comprise receiving, via the processor, transaction information associated with a real estate transaction. The operations may further comprise generating, via the processor, a user portal for facilitating the transfer of the good funds payment in response to a user's name and a user's contact in the transaction information, the user portal configured to be accessed through a secure payment user interface (UI).

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a schematic view of a system having a secure payment system in a home buying process, in accordance with various embodiments;

FIGS. 2A and 2B illustrate a secure payment process, in accordance with various embodiments;

FIG. 3 illustrates a flow of funds in a secure payment process, in accordance with various embodiments;

FIG. 4 illustrates a secure payment process, in accordance with various embodiments; and

FIG. 5 illustrates a system of FIG. 1 having a network of financial institutions, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Secure payment systems and methods are disclosed herein. The secure payment systems and methods may comprise a computer-based system for transferring large sums of good funds from an individual to an escrow or title company during a home buying process. Secure payment systems and methods disclosed herein enable automation of good funds transfers from an individual to an escrow account that previously could not and have not been automated as outlined in the background section.

In the technical field of providing secure good fund transfers for earnest money payments and final closing payments, manual processes of verification are typically used, settlement of funds may take days, and/or transfer of funds may be susceptible to scammers. In various embodiments, the systems and methods disclosed herein make it easier, quicker, and more secure for home buyers to pay a good fund earnest money deposits or a final closing payments during a home buying process relative to typical systems and methods for transferring good funds from an individual account to an escrow account. For example, the systems and methods disclosed herein allow a home buyer to facilitate a final payment through a secure payment system and make the payment via a credit push from the home buyer's own financial institution via a real-time payment (RTP) without any interaction with the receiving financial institution of a respective title or escrow company. Thus, by providing a means for the home buyer to make the final payment via a real-time (i.e., within a few minutes) payment (RTP) already defined above process, the payment process may be quicker, more secure, and may be performed without manual processes of wire transfers and cashiers' checks as previously disclosed herein. Thus, the systems and methods disclosed herein provide a significant improvement in the technical field of transferring large sums of good funds from an individual account to an escrow account, and therefore are integrated into a practical application, in accordance with various embodiments.

In various embodiments, the systems and methods disclosed herein are more convenient than a typical transfer of good funds for a real estate transaction. For example, the secure payment system disclosed herein is significantly more accessible by being available twenty-four hours a day, seven days a week, 365 days a year, compared to typical bank hours of prior systems, in accordance with various embodiments. Additionally, the system and methods disclosed herein are easier and/or faster relative to typical systems and methods for transferring good funds because a buyer may perform the process automatically through their own device without having to go to a bank in person and/or call a title company or escrow company to verify account information, in accordance with various embodiments. In various embodiments, the system and processes disclosed herein facilitate immediately and irrevocably (i.e., in less than three minutes) as opposed to a typical wire transfer which may take up to a day. In this regard, time is saved by the home buyer, the title company, and the financial institution during the process disclosed herein, in accordance with various embodiments. In various embodiments, the systems and processes disclosed herein are automated, as opposed to a manual process currently, have fewer verifications, are more easily identifiable, and/or allow for larger amounts of good funds to be transferred compared to current systems and processes for transferring good funds. For example, wiring good funds typically utilizes a bank teller and a title company or escrow company to verify the account number prior to sending the wire, both of which are eliminated by the system and processes disclosed herein, in accordance with various embodiments. In various embodiments, larger amounts of money may be transferred by home buyers relative to typical systems as the secure payment system disclosed herein greatly reduces a risk of fraudsters as described further herein.

In various embodiments, the systems and methods disclosed herein are more secure relative to typical systems and methods for transferring good funds from an individual to a title or escrow company. For example, since the home buyer does not input the destination of the funds, and the destination is automatically associated with the home buyer via the secure payment system, a buyer may be more protected from sending funds to a fraudulent account, which has been a significant problem of typical systems and methods of transferring good funds, in accordance with various embodiments. In various embodiments, the systems and methods disclosed herein remove a possibility, or threat, of fraudulent cashier's checks being provided to a title or escrow company, saving time and money for the title or escrow company. In various embodiments, the systems and methods disclosed herein have a greater level of authentication relative to typical systems and methods (i.e., authentication of buyer through the secure payment system and authentication of buyer through their financial institution system prior to transfer of the good funds). In various embodiments, the source and destination of the funds are more easily identifiable relative to typical systems.

In various embodiments, systems and methods disclosed herein may provide a more affordable option for users as fees of financial institutions for a credit push disclosed herein may be significantly less than a typical wire transfer, cashier's check, or the like.

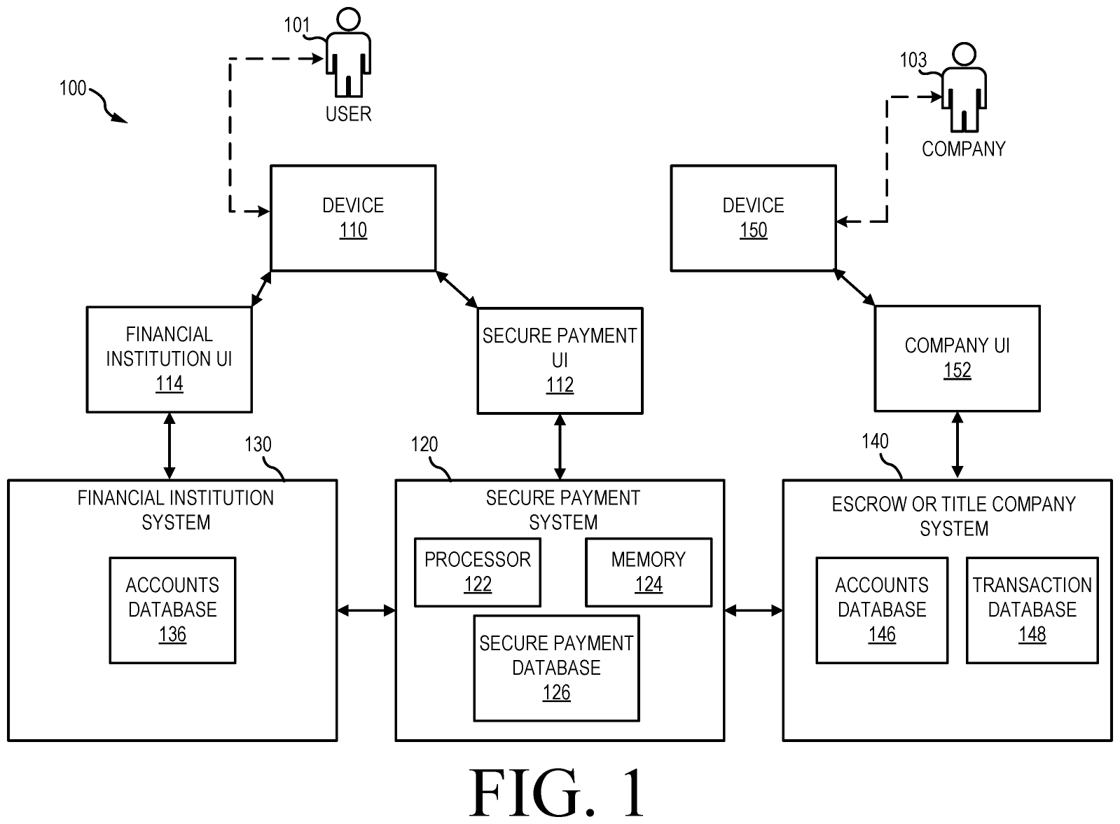

Referring now to FIG. 1, a secure good funds payment system 100 for use in a home buying process is illustrated, in accordance with various embodiments. In various embodiments, the system 100 comprises a secure payment system 120 comprising a processor 122 and a memory 124. Secure payment system 120 is in communication with a secure payment user interface (UI) 112, which may be displayed and accessible through a device 110. Secure payment system 120 is further in communication with a network of financial institutions including the financial institution 130 of a user 101, as well as a network of escrow or title company financial institutions including an escrow or title company for the user 101 for a respective home buying process as described further herein. System 100 may be configured for facilitating a secure good funds payment from the financial institution 130 of user 101 to the escrow or title company financial institution without any action by the company 103, which may be a title company, an escrow company, or any other company used for facilitating closing during a good funds transfer of a home buying process. In particular, during a typical good funds payment process, the company 103 shares information pertaining to an escrow account for the good funds payment with the user 101, such as an account number and routing number associated with the escrow account. Additionally, the company 103 typically has the user 101 call the company 103 and verify the numbers prior to submitting a wire transfer or obtaining a cashier's check. In contrast, the secure good funds payment system 100 disclosed herein provides no action by the company 103 during the secure payment process by user 101 as described further herein. Such stations may share any of the devices or resources shown in FIG. 1.

In various embodiments, and as shown in FIG. 1, secure payment system 120 may store a software program configured to perform the methods described herein in the memory 124 and run the software program using the processor 122. The secure payment system 120 may include any number of individual processors 122 and memories 124. Various data may be communicated between the secure payment system 120 and a user 101 via the secure payment UI 112. Such information may also be communicated between the secure payment system 120 and the financial institutions (e.g., consumer's financial institution 130 and escrow or title company financial institution 140), databases (e.g., account databases 136, 146 or transaction database 148) and/or any other computing device connected to the secure payment system 120 (e.g., through any network such as a local area network (LAN), or wide area network (WAN) such as the Internet).

In various embodiments, in system 100 depicted in FIG. 1, the processor 122 retrieves and executes instructions stored in the memory 124 to control the operation of the secure payment system 120. Any number and type of processor(s) (e.g., an integrated circuit microprocessor, microcontroller, and/or digital signal processor (DSP)), can be used in conjunction with the various embodiments. The processor 122 may include, and/or operate in conjunction with, any other suitable components and features, such as comparators, analog-to-digital converters (ADCs), and/or digital-to-analog converters (DACs). Functionality of various embodiments may also be implemented through various hardware components storing machine-readable instructions, such as application-specific integrated circuits (ASICs), field-programmable gate arrays (FPGAs) and/or complex programmable logic devices (CPLDs).

The memory 124 may include a non-transitory computer-readable medium (such as on a CD-ROM, DVD-ROM, hard drive or FLASH memory) storing computer-readable instructions thereon that can be executed by the processor 122 to perform the methods of the present disclosure. The memory 124 may include any combination of different memory storage devices, such as hard drives, random access memory (RAM), read only memory (ROM), FLASH memory, or any other type of volatile and/or nonvolatile memory.

The secure payment system 120 may receive, and query information (such as information related to a financial institution of a user 101) via the secure payment UI 112. The user interfaces (e.g., the secure payment UI 112 and/or the financial institution UI 114) may include various peripheral output devices (such as monitors and printers), as well as any suitable input or control devices (such as a mouse and keyboard) to allow users to control and interact with the software program.

In various embodiments, device 110 may each be in electronic communication with secure payment system 120 and/or a financial institution of user 101, directly or via a respective user interface (e.g., secure payment UI 112 and/or second financial UI 114). Device 110 may comprise any suitable hardware, software, and/or database components capable of sending, receiving, and storing data. For example, device 110 may comprise a personal computer, personal digital assistant, cellular phone, smartphone (e.g., IPHONE®, BLACKBERRY®, and/or the like), IoT device, and/or the like. Device 110 may comprise an operating system, such as, for example, a WINDOWS® mobile operating system, an ANDROID® operating system, APPLE® IOS®, a BLACKBERRY® operating system, a LINUX® operating system, and the like. Device 110 may also comprise software components installed on device 110 and configured to enable access to various system 100 components. For example, device 110 may comprise a web browser (e.g., MICROSOFT INTERNET EXPLORER®, GOOGLE CHROME®, etc.), an application, a micro-app or mobile application, or the like, configured to allow the device 110 to access and interact with secure payment system 120 and/or financial institution system 130 (e.g., directly or via a respective UI, as discussed further herein).

In various embodiments, device 110 may be configured to communicate with and/or interact with secure payment system 120 via the secure payment UI 112. Secure payment UI 112 may comprise a graphical user interface (GUI) accessible via a mobile application, web browser, software application, or the like. For example, device 110 may interact with secure payment UI 112 to provide payment information corresponding to a good funds payment for a home buying process, such as their financial institution (e.g., the financial institution associated with financial institution system 130), an amount to be transferred (i.e., the good funds payment), and/or any other information queried by the secure payment UI 112 as disclosed further herein. Device 110 may also interact with the financial institution UI 114 during the secure payment process to accept a request for payment (RFP) from, or through, the secure payment system 120. For example, financial institution UI 114 may display a message generated from the secure payment system 120 with a request for payment to a respective escrow or title company financial institution 140 based on the information provided by user 101 via the secure payment UI 112.

In various embodiments, the secure payment system 120 comprises a secure payment database 126 in communication with the processor 122. In various embodiments, as described further herein, the secure payment database 126 stores and/or compiles information related to escrow or title companies closing accounts, escrow accounts, or the like. The database 126 may be implemented on secure payment system 120 directly or hosted by another system or device (such as a server) in communication with the secure payment system 120 via, for example, a network such as a LAN or WAN. In various embodiments, database 126 may be implemented as a relational database.

In various embodiments, the system 100 further comprises a device 150 for use by a company user 103. In various embodiments, through a company UI 152, the company user 103 may input various information for a respective transaction (e.g., an account number, an escrow account for funds to be transferred into, a name of a buyer on the account, an email address for the buyer, a property being sold, and/or any additional information for a respective transaction). In various embodiments, the transaction information may further include any good fund payment amounts owed, any due dates for the respective good fund payment amounts, or the like. In various embodiments, the company UI 152 is in operable communication with the escrow title or company system 140. In this regard, in response to receiving the transaction information, the escrow or title company system may store the transaction information in the transaction database 148 and send a notification to the secure payment system 120 with the transaction information. The secure payment system 120 may be configured to operate automatically on the information provided for a respective transaction without any further input from a company user 103, in accordance with various embodiments. For example, through processor 122, the secure payment system 120 may automatically generate and send a correspondence to device 110 of the user 101 (e.g., through an email associated with the email address from the transaction information), containing a link associated with the transaction (e.g., a pay now link, a link to the secure payment UI 112, or the like) on a date determined from a respective due date (obtained from the transaction information), in accordance with various embodiments.

In various embodiments, the escrow or title company system 140 is in operable communication with the secure payment system 120 (i.e., via a network or the like). In various embodiments, in response to a new transaction being entered into the escrow or title company system 140, the processor 122 of the secure payment system 120 may receive a notification that the new transaction has been entered. In response to receiving the notification, the processor 122 may generate a transaction identifier for the new transaction and send the identifier to the secure payment database 126. In various embodiments, the processor 122 may additionally set a predetermined time to generate and send a secure payment link to a respective buyer associated with a respective transaction based on a respective due date for the transaction. In this regard, in response to the predetermined time being met (e.g., two days before a transaction due date), the secure payment system 120, via the processor 122, may generate and send a link (e.g., via an email or text) to a user device 110, in accordance with various embodiments. In various embodiments, in response to clicking on the link, the user 101 may utilize a secure payment UI 112 to generate a request for good funds payment as described further herein.

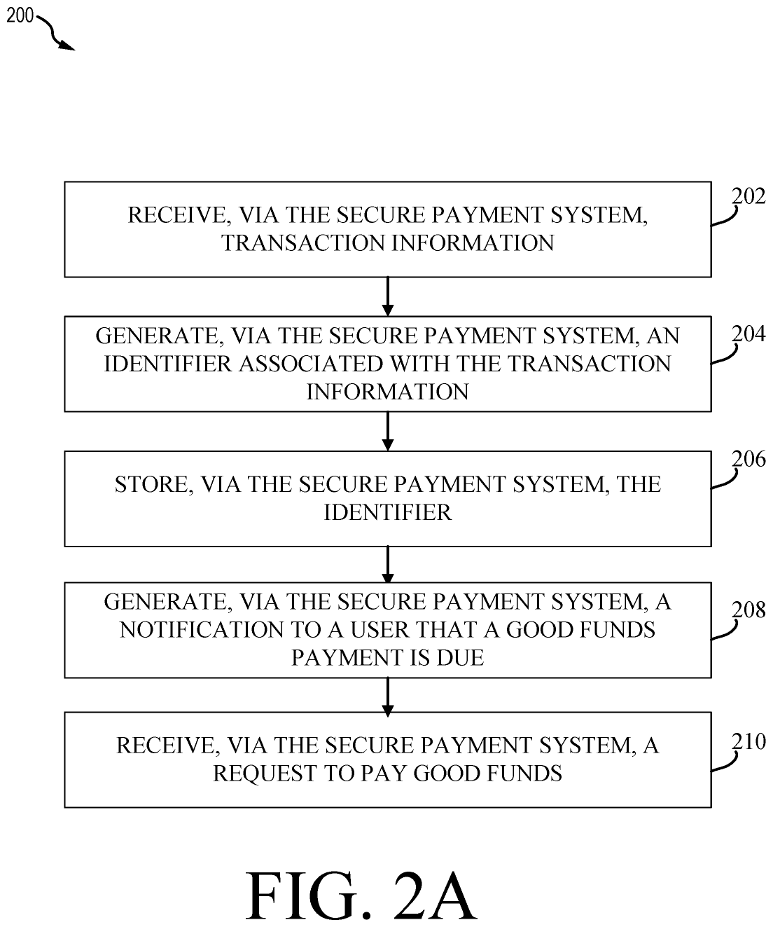

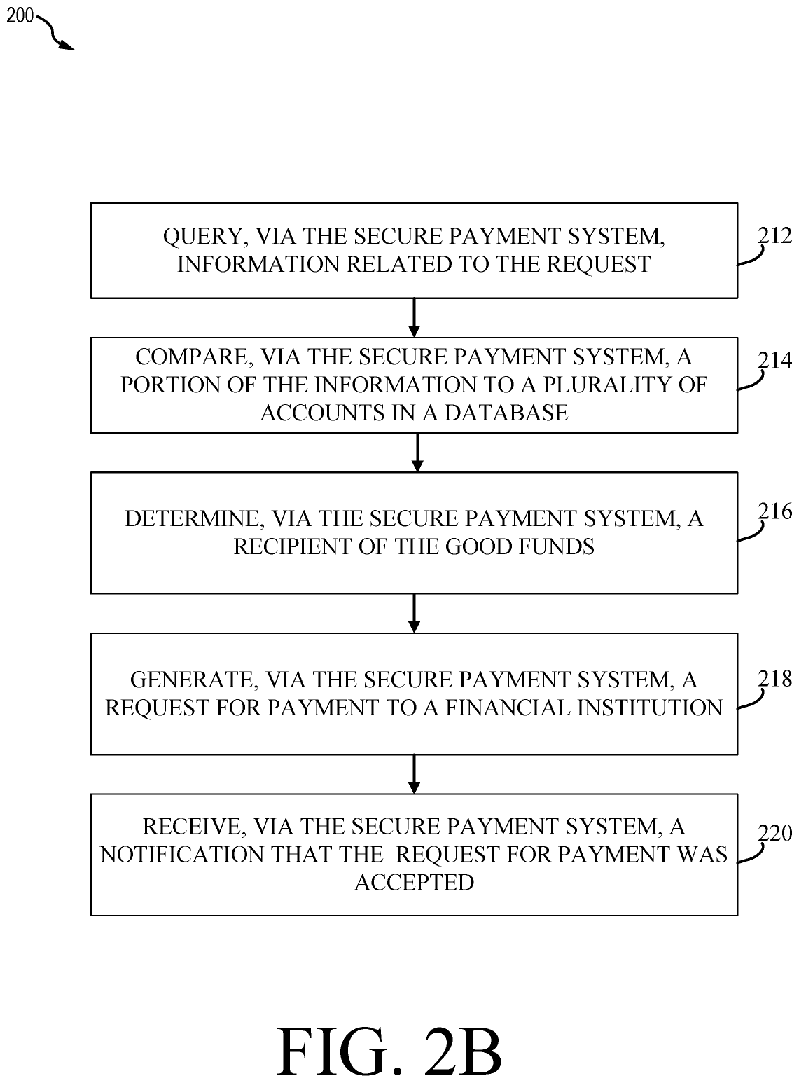

Referring now to FIGS. 2A and 2B, a secure payment process 200 of a secure payment system 120 from FIG. 1 is illustrated, in accordance with various embodiments. The secure payment process 200 comprises receiving, via the secure payment system, transaction information associated with a newly generated transaction from an escrow or title company (step 202). The transaction information may include any amount of information associated with the transaction (e.g., escrow account number, a buyer name, a buyer contact email, a property address, etc.). In various embodiments, the transaction information may not initially include information related to a buyer (i.e., the buyer information may be put into the system at a later date). In response to receiving the transaction information, the secure payment system may generate an identifier associated with an escrow account for the transaction (step 204). In various embodiments, the process 200 further comprises storing, via the secure payment system and in a secure payment database 126 from FIG. 1, the identifier (step 206). The identifier may be associated with an escrow account information, such as account number, routing number, name of account, etc. In this regard, the secure payment system 120 from FIG. 1 may utilize less memory and have faster processing relative to typical systems which also include the escrow account information for every transaction.

In various embodiments, the process 200 further comprises generating, via the secure payment system and through the processor, a notification to a user that a good funds payment is due (step 208). The notification may be generated in response to various triggers from secure payment system 120 from FIG. 1. For example, the notification may be sent a predetermined time period prior to a respective due date for the good funds transaction set by the company 103 of FIG. 1 via the company UI 152, which may be communicated to the secure payment system 120 and stored in the secure payment database 126, in accordance with various embodiments. In various embodiments, the company user 103 may set a date manually for the notification to be sent, the notification may be automatically generated in response to the secure payment system receiving information associated with a buyer (e.g., email address, phone number, name, etc.), or the like. In various embodiments, the notification may include a link to make a request for payment as described further herein, a link to a portal (e.g., secure payment UI 112) associated with the transaction from step 202, or the like.

In various embodiments, in response to selecting the link, the user 101 from FIG. 1 may utilize a two-factor authentication based on the buyer information from the transaction information in step 202 of process 200. For example, the user 101 may click on the link indicating that the user 101 is likely the intended user. Then, in response to clicking on the link, a code may be sent (e.g., via text or email associated with the user based on the buyer information) for the user to enter on the screen. In this regard, the secure payment system may provide additional security in verifying a user prior to the user 101 from FIG. 1 being able to request a payment of good funds as described further herein.

In various embodiments, the process 200 further comprises receiving, via a secure payment system 120, a request to send good funds from a first user (e.g., user 101 from FIG. 1) to a second user (e.g., a company 103 from FIG. 1) (step 210). In various embodiments, the user 101 may be a home buyer, or the like. The second user may be a title company, an escrow company, or any other receiver of good funds in a real estate transaction requiring good funds, in accordance with various embodiments.

The secure payment process 200 further comprises querying, via the secure payment system 120, information related to the request to send good funds of step 210 (step 212). In this regard, the secure payment system 120 of FIG. 1, via the processor 122, may display through the secure payment UI 112 on the device 110 a query requesting information from user 101. For example, the information may include selecting a title or escrow company, verifying a financial institution of the user 101 for transferring the good funds (e.g., providing routing number, account number, name on account etc.). In various embodiments, the systems and methods disclosed herein facilitate a smoother transaction relative to typical manual systems described previously herein. In this regard, a title or escrow company may agree to use secure payment system 120 for secure payments of good funds prior to any specific secure payment process 200. Thus, a user 101 from FIG. 1 may be able to select their specific title or escrow company from a list of title or escrow companies that are utilizing the secure payment system 120. In various embodiments, by allowing a user to select their specific title company from a pre-set list, the systems and methods disclosed herein have little to no verification interaction between the user 101 and the title or escrow company (e.g., company 103) during the secure payment process 200. This may be immensely beneficial for an escrow or title company, as they do not have to expend the time and effort ensuring good funds are sent to them from user 101 as opposed to a scammer as outlined previously, in accordance with various embodiments. Additionally, work hours may be reduced for the title or escrow company as the process 200 is more hands off relative to typical manual transfers of good funds in the home buying processes.

The process 200 further comprises comparing, via the secure payment system 120, a portion of the information to a plurality of accounts in an account database (step 214). In this regard, based on the selected title or escrow company in step 212, the secure payment system 120 may be configured to retrieve account information from an account database 146 of the escrow or title company financial institution 140 from FIG. 1 that was selected, and compare a name of the user 101 to a plurality of names associated with a plurality of escrow or title accounts in the account database 146.

In response to finding a match between the name of the user 101 and a name on a respective account in the plurality of escrow or title accounts in the account database 146, the process 200 determines a recipient (i.e., a recipient account) of the good funds (step 216). By having the secure payment system 120 in communication with an account database of each escrow or title company that utilizes secure payment system 120, the secure payment system 120 is able to determine and/or verify a recipient of the good funds without any input by the escrow or title company, in accordance with various embodiments.

In various embodiments, the process further comprises generating, via the secure payment system, a request for payment (RFP) already defined above to the financial institution of the first user (step 218). In various embodiments, the first user may be able to review the RFP generated via the secure payment system through a graphical user interface (GUI) associated with the first user's financial institution (e.g., financial institution UI 114 from FIG. 1). In this regard, the first user may review the RFP to ensure the amount of good funds is correct and either accept or reject the RFP.

The secure payment process 200 further comprises receiving, via the secure payment system, an approval from the financial institution of the first user of the RFP (step 220). In response to receiving the approval from the financial institution, the secure payment system transfers the requested funds from the financial institution of the first user to a financial institution of the secure payment system as described further herein.

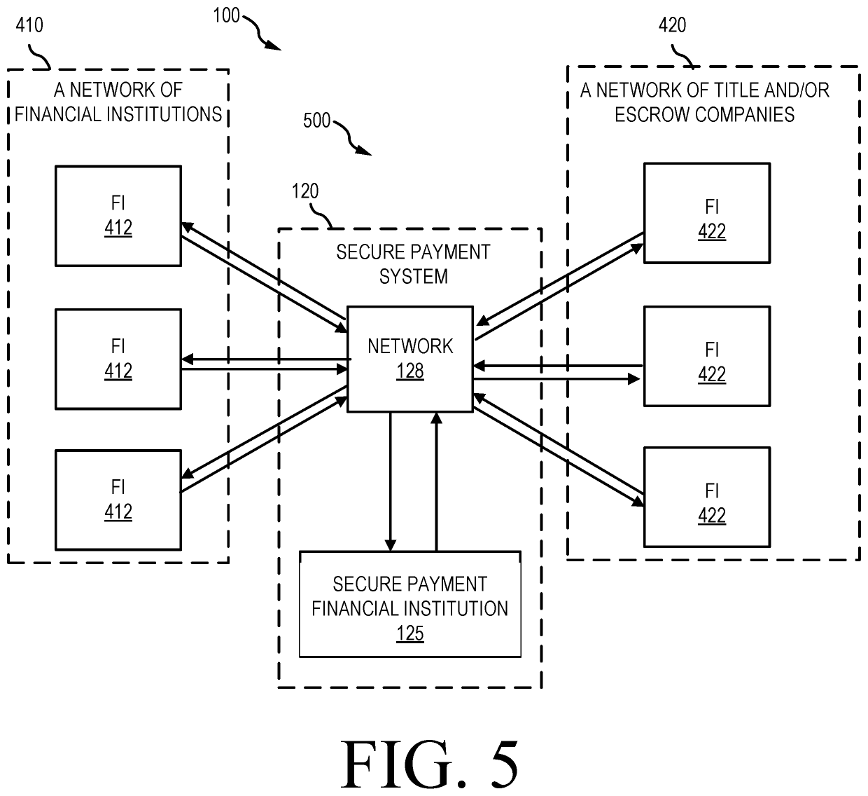

In various embodiments, the secure payment process 200 is facilitated through a credit push only system (i.e., the funds cannot be pulled from one financial institution to the next). In this regard, since the funds are credit push only, the financial institution sending the funds can verify that the funds are good funds prior to sending. Additionally, by utilizing a credit push only system through a secure payment system disclosed herein, the sender and receiver are verified, trusted institutions. Thus, when compared to typical payment systems for home buying, the secure payment system disclosed herein is significantly safer, more secure, and faster, in accordance with various embodiments. In various embodiments, the transfer of step 220 may be via a real-time payment process, a FedNow process, or the like. In this regard, the funds may be transferred and verified as good funds within minutes. An RTP process as disclosed herein refers to payments that are initiated and settled nearly instantaneously. “Nearly instantaneously” as referred to herein is less than three minutes, in accordance with various embodiments. The RTP process disclosed herein may be facilitated via a real-time payment network 500 as illustrated in FIG. 5.

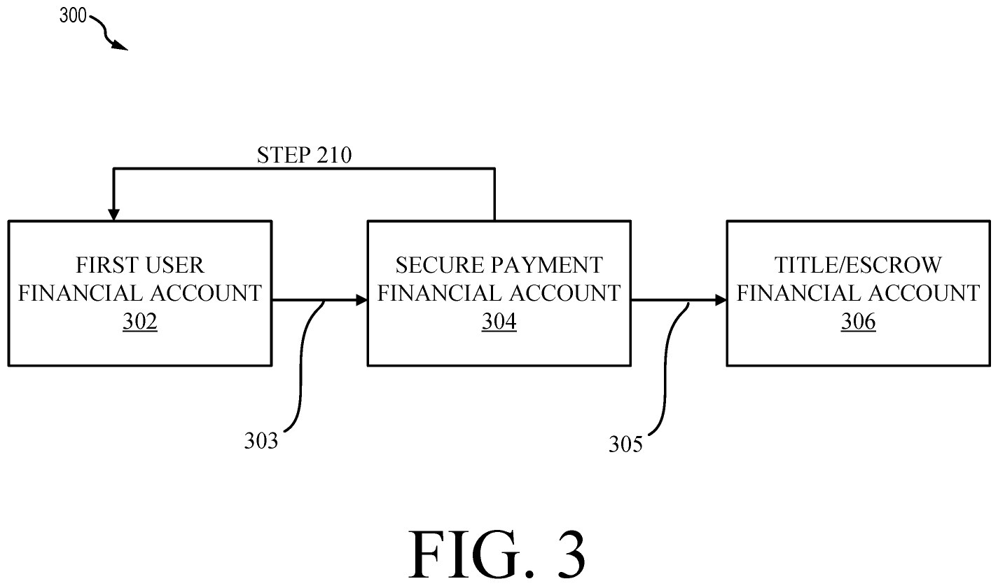

Referring now to FIG. 3, a flow of funds process 300 in response to utilizing system 100 from FIG. 1 is illustrated, in accordance with various embodiments. In various embodiments, the secure payment system 120 from FIG. 1 further comprises a secure payment financial account 304. Similarly, the financial institution system 130 may comprise a first user financial account 302 stored in the account database 136 from FIG. 1, and the title and/or escrow system 140 may comprise a title/escrow financial account 306 stored in the accounts database 146.

In various embodiments, in response to an RFP being generated via step 218 from process 200 in FIG. 2, the financial institution system 130 from FIG. 1 receives the RFP. If the RFP is accepted by an account holder (i.e., user 101 from FIG. 1), a credit push of good funds is facilitated from the first user financial account 302 to the secure payment financial account 304 via a near instantaneous transfer 303 (i.e., within three minutes). The near instantaneous transfer 303 may be initiated from the first user financial account 302 and settled within the secure payment financial account 304, in accordance with various embodiments. In various embodiments, in response to receiving the good funds in the secure payment financial account 304, the secure payment system 120 from FIG. 1 may transfer the good funds to the title/escrow financial account 306 via a similar credit push, a wire transfer, or the like. In various embodiments, the secure payment financial account 304 may be a for-benefit of (FBO) account on behalf the title/escrow company (e.g., company 103 from FIG. 1).

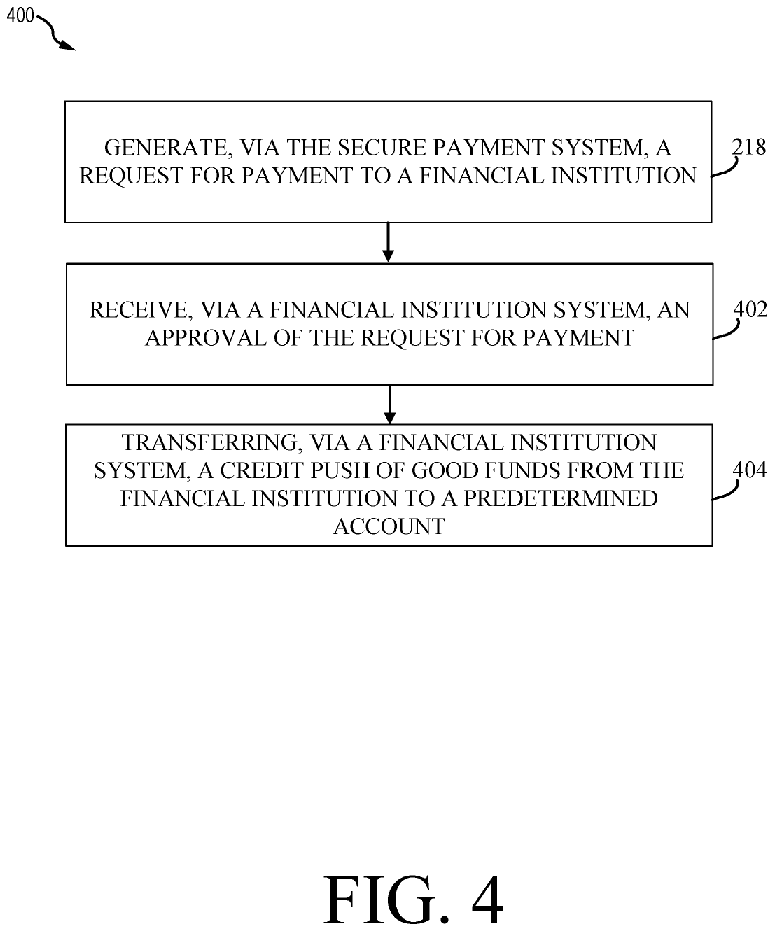

Referring now to FIG. 4, a process for the secure payment system 120 from FIG. 1 is illustrated, in accordance with various embodiments. The process 400 comprises generating, via the secure payment system, a request for payment to a financial institution (step 218 of FIG. 2B). The request for payment may be sent to an account in the financial institution associated with the user 101 from FIG. 1. The account information may have been obtained in the querying step 212, or via a two-factor authentication of a user's bank account, or the like.

In various embodiments, the process 400 further comprises receiving, via a financial institution system 402, an approval of the request for payment (step 402). In this regard, user 101 from FIG. 1 may log in to an account associated with his or her financial institution through the financial institution UI 114 on the device 110 of user 101 and approve a request for good funds generated from the secure payment system 120 from FIG. 1. In this regard, the user 101 is able to both initiate the request for good funds and approve the request for good funds in a secure manner without any input from company 103 or any other third party sources, in accordance with various embodiments.

In various embodiments, the process 400 further comprises transferring, via a financial institution system, a credit push of good funds from a user account of financial institution to a predetermined account (step 404). In various embodiments the predetermined account is a secure payment account of secure payment system. In this regard, the secure payment account may be an intermediary between the user account and the final destination (i.e., a title account or an escrow account). In various embodiments, the predetermined account may be the final destination account (i.e., the good funds may be transferred directly to the title account or the escrow account associated with the transaction).

Referring now to FIG. 5, a schematic view of system 100 from FIG. 1 including a real-time payment network 500 for use with the secure payment system 120 is illustrated, in accordance with various embodiments. In various embodiments, the secure payment system 120 further comprises a network 128 and a secure payment financial institution including a secure payment account 125 for facilitating secure payments as disclosed herein. In various embodiments, the secure payment system 120 may comprise a single secure payment account 125 for funneling good funds from a user account in a user financial institution in the network of user financial institutions 410 and an escrow account in a title and/or escrow company financial institution in a network of title and/or escrow company financial institutions 420. In various embodiments, the secure payment system 120 may comprise a plurality of the secure payment account, each secure payment account in the plurality of secure payment accounts associated with a specific escrow account for a specific home buying transaction from the network of title and/or escrow company financial institutions 420. For example, a secure payment account 125 may be an FBO account associated with a specific escrow account of a specific mortgage, in accordance with various embodiments.

In various embodiments, each financial institution (e.g., financial institutions 422) in the network of title and/or escrow company financial institutions 420 are in communication with the secure payment system 120 through network 128. In this regard, in response to a new escrow account being opened for a specific home buying transaction within a financial institution in the network of title and/or escrow company financial institutions 420, the secure payment system 120 may receive an indication the new escrow account was opened. In response to receiving the indication, the secure payment system 120, via the processor 122 from FIG. 1, may generate a user portal associated with the new escrow account for a home buyer associated with the new escrow account to utilize in order to facilitate an earnest good funds deposit and/or a closing good funds payment, in accordance with various embodiments. In this regard, in response to a typical process of opening an escrow account by a title and/or escrow company, a user portal directly associated with the new escrow account may automatically be generated by the secure payment system. By automatically tying the user portal directly to the new escrow account, the secure payment system 120 may reduce an amount of work by title and/or escrow companies in verifying the funds are transferred to the correct account, in accordance with various embodiments. Furthermore, a process of verifying that good funds are transferred to the correct account has typically involved a user calling and verifying the escrow account information, which now is automatic and more secure, in accordance with various embodiments.

In various embodiments, in response to querying step 212 from processes 200, 400, the secure payment system 120, via processor 122 from FIG. 1, may determine a financial institution in the network of user financial institutions 410 associated with the respective user. In this regard, the secure payment system 120 may generate the request for payment to a user account in the respective user financial institution (e.g., one of financial institutions 412), through the network 128. In this regard, the respective user (e.g., user 101 from FIG. 1) may review the request for payment through a financial institution UI 114 from FIG. 1, which the user generated through the secure payment system 120 in step 212 as outlined previously herein.

In various embodiments, by allowing a user to facilitate the good funds payment through the secure payment system 120 and approve the payment through the financial institution system 130, a secure, more efficient, and automatic transfer of good funds is initiated as opposed to the manual process in typical earnest money and closing payment transactions.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

1. A method of transferring good funds, comprising:
receiving, by a secure payment system, transaction information associated with a real estate transaction, the transaction information including an escrow account, a user name, and a user contact, the escrow account configured to receive a good funds payment;
generating, by the secure payment system, a user portal associated with the transaction information;
transmitting, by the secure payment system, a link to the user portal;
receiving, by the secure payment system and through the user portal, a first a good funds transfer request to transfer the good funds payment from a user account of a user to the escrow account;
querying, by the secure payment system and through the user portal, information associated with the real estate transaction;
receiving, by the secure payment system and through the user portal, a financial institution for the user account;
generating, by the secure payment system and through a financial institution user interface of the financial institution, an approval request for payment of the good funds payment to the financial institution associated with the user account;
transmitting, by the secure payment system and through a user device, the approval request to the financial institution user interface;
receiving, by the secure payment system, a notification that the approval request for payment was approved by the user; and
in response to the approval request for payment being approved by the user, irrevocably transferring the good funds payment from the user account of the user to one of a secure payment account of the secure payment system or the escrow account, wherein:
the good funds payment is settled within three minutes of the transferring the good funds payment being initiated by the user, and
funds from the good funds payment are available for use in response to the good funds payment being settled.

2. The method of claim 1, wherein the good funds transfer request to transfer the good funds payment is initiated by the user.

3-4. (canceled)

5. The method of claim 1, wherein the good funds transfer request to transfer the good funds payment and approval of the approval request for payment are both performed by the user.

6. The method of claim 1, wherein receiving the first request to transfer the good funds payment is received through a secure payment user interface (UI).

7. The method of claim 6, wherein querying the information associated with the user account is performed through the secure payment UI.

8. A system for transferring good funds, comprising:
a network of first financial institutions, each financial institution in the network of first financial institutions including a plurality of individual accounts;
a network of second financial institutions, each second financial institution in the network of second financial institutions including a plurality of escrow accounts, each escrow account in the plurality of escrow accounts being opened to facilitate a home buying process;
a secure payment system comprising a processor, a secure payment account, a user portal, and a tangible, non-transitory memory configured to communicate with the processor, the tangible, non-transitory memory having instructions stored thereon that, in response to execution by the processor, cause the processor to perform operations comprising:
transmitting, by the processor, a link to the user portal;
receiving, by the processor and through the user portal, a good funds transfer request to transfer a good funds payment from a user account in the plurality of individual accounts to a user associated escrow account in the plurality of escrow accounts;
querying, by the processor and through the user portal, information associated with the user account;
receiving, by the processor and through the user portal, a user financial institution in the network of first financial institutions associated with the user account of a user in response to querying the information associated with the user account;
generating, by the processor and through a financial institution user interface of the financial institution, an approval request for payment of the good funds payment to the user financial institution;
transmitting, by the secure payment system and through a user device, the approval request to the financial institution user interface;
receiving, by the processor, a notification that the user approved the approval request for payment, wherein in response to the approval request for payment being approved, the good funds payment is automatically transferred from the user account to the secure payment account, wherein:
the good funds payment is settled within the secure payment account within three minutes of the transferring the good funds payment being initiated by the user, and
funds from the good funds payment are available for use in response to the good funds payment being settled.

9. The system of claim 8, wherein in response to receiving the good funds payment in the secure payment account, the good funds payment is automatically transferred to the user associated escrow account.

10. The system of claim 8, wherein:
the user financial institution comprises a financial system including a graphical user interface (GUI), and
approval of the second request for payment is received from the user through the GUI of the financial system of the user financial institution.

11-12. (canceled)

13. The system of claim 8, wherein:
the secure payment system further comprises a secure payment user interface (UI), and
the processor configured to generate a portal for the user in response to a user name and a user contact being provided for a respective transaction.

14. The system of claim 13, wherein the secure payment UI is configured to allow the user to access the portal.

15. An article of manufacture including a tangible, non-transitory computer-readable storage medium having instructions stored thereon that, in response to execution by a processor, cause the processor to perform operations comprising:
receiving, by the processor, a first request to transfer a good funds payment from a user account into an escrow account, the escrow account configured to receive one of an earnest money deposit and a final closing payment;
generating, by the processor, a user portal associated with the transaction information;
transmitting, by the secure payment system, a link to the user portal;
querying, by the processor and through a user portal, information associated with the user account;
determining, by the processor and through the user portal in response to the querying, a financial institution associated with the user account and an amount for the good funds payment;
generating, by the processor and through a financial institution user interface of the financial institution, an approval request for payment of the amount to the financial institution associated with the user account;
receiving, by the processor, a notification that the approval request for payment of the amount was approved by the user; and
in response to an approval by a user of the approval request for payment, the amount for the good funds payment is irrevocably transferred from the user account to one of a secure payment account associated with the escrow account or the escrow account, wherein:
the good funds payment is settled within the secure payment account within three minutes of the transferring the good funds payment being initiated by the user, and
funds from the good funds payment are available for use in response to the good funds payment being settled.

16. (canceled)

17. The article of manufacture of claim 15, wherein the operations further comprise generating, via the processor, a user notification to the user that the good funds payment is due, the user notification including one of an email and a text message, the user notification comprising the link to the user portal.

18. The article of manufacture of claim 15, wherein in response to receiving the good funds payment in the secure payment account, the good funds payment is transferred to a user associated escrow account.

19. The article of manufacture of claim 15, wherein the operations further comprise receiving, via the processor, transaction information associated with a real estate transaction.

20. The article of manufacture of claim 19, wherein the user portal for facilitating the transfer of the good funds payment is generated automatically in response to a user name and a user contact in the transaction information being received by the processor, the user portal configured to be accessed through a secure payment user interface (UI).
